(19) United States
(12) Patent Application Publication
(10) Pub. No.: US 2007/0226624 A1
(43) Pub. Date: Sep. 27, 2007

(54) Content-based video summarization using spectral clustering

(76) Inventors: Kadir A. Peker, Burlington, MA (US); Faisal I. Bashir, Youngstown, OH (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/361,829

(22) Filed: Feb. 23, 2006

(51) Int. Cl. G06F 3/00; G06K 9/62

(52) U.S. Cl. 715/719; 382/224

(57) ABSTRACT

A method summarizes a video including a sequence of frames. The video is partitioned into segments of frames, and faces are detected in the frames of the segments. Features of the frames including the faces are extracted. For each segment including the faces, a representative frame based on the features is selected. For each possible pair of representative frames, distances are determined based on the faces. The distances are arranged in a matrix. Spectral clustering is applied to the matrix to determine an optimal number of clusters. Then, the video can be summarized according to the optimal number of clusters.

### FIELD OF THE INVENTION

This invention relates generally to summarizing videos, and more particularly to detecting faces in videos to perform unsupervised summarization of the videos.

### BACKGROUND OF THE INVENTION

Content-based summarization and browsing of videos can be used to view the huge amount of videos produced every day. One application domain for video summarization systems is personal video recorder (PVR) systems, which enable digital recording of several days' worth of broadcast video on a disk device.

Effective content-based video summarization and browsing technologies are crucial to realize the full potential of these systems. Genre specific content-segmentation, such as for news, weather, or sports videos, has produced good results, see, e.g., T. S. Chua, S. F. Chang, L. Chaisom, W. Hsu, “Story Boundary Detection in Large Broadcast News Video Archives—Techniques, Experience and Trends,” ACM Multimedia Conference, 2004.

The field of content-based unsupervised generation of video summaries is still in its infancy. Unsupervised summarization does not require any user intervention. To summarize videos from a wide variety of genres without user intervention or training is even more difficult.

Generating semantic summaries requires a significant amount of face recognition and supervised learning. It is desired to avoid this for two reasons. First, typical consumer video play back devices, such as personal video recorders, have limited resources. Therefore, it is not possible to implement a method that requires high-dimensional feature spaces, or uses complex non real-time processes. Second, any supervised method will ultimately require training data. This results in a genre-specific solution. When the summary is based on face recognition, many conventional face recognition techniques do not work well on normal news or TV programs due to a large variation in pose and illumination of the faces.

It is desired to provide a generic end-to-end summarization system that works on various genres of videos from multiple content providers, without user supervision and training.

### SUMMARY OF THE INVENTION

A method summarizes a video including a sequence of frames. The video is partitioned into segments of frames, and faces are detected in the frames of the segments.

Features of the frames including the faces are extracted. For each segment including the faces, a representative frame based on the features is selected. For each possible pair of representative frames, distances are determined. The distances are arranged in a matrix.

Spectral clustering is applied to the matrix to determine an optimal number of clusters. Then, the video can be summarized according to the optimal number of clusters.

### BRIEF DESCRIPTION OF THE DRAWINGS

FIG. 1 is a flow diagram of a method for summarizing a video according to an embodiment of the invention.

### DETAILED DESCRIPTION OF THE PREFERRED EMBODIMENT

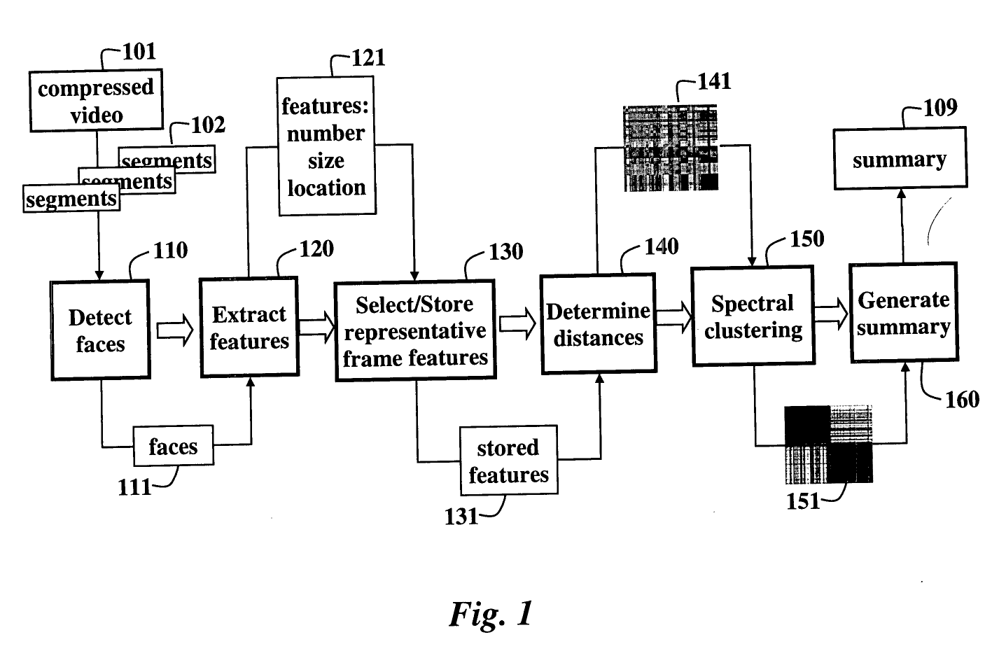

FIG. 1 shows a method for summarizing a video 101 of an unknown genre according to an embodiment of our invention. In a preffered embodiment, the video 101 is compressed according to a MPEG standard. The compressed video includes I-frames and P-frames. We use the I-frames or ‘DC’ images. Texture information is encoded as discrete cosine transform (DCT) coefficients in the DC images. If we use DC images, then the processing time is greatly decreased. However, it should be understood that the method described herein can also operate on uncompressed videos, or videos compressed using other techniques.

We partition the video 101 into overlapping segments 102 or ‘windows’ of approximately ninety frames each. At thirty frames per second, the segments are about three seconds in duration. The overlapping window shifts forward in time in steps of thirty frames or about one second.

Faces 111 are detected 110 in the segmented video 101. The faces are detected using an object detection method described by P. Viola, M. Jones, “Robust real-time object detection,” IEEE Workshop on Statistical and Computational Theories of Vision, 2001; and in Viola et al., “System and Method for Detecting Objects in Images,” U.S. patent application Ser. No. 10/200,464, filed Jul. 22, 2002 and allowed on Jan. 4, 2006, both incorporated herein by reference. That detector provides high accuracy and high speed, and can easily accommodate detection of objects other than faces depending on a parameter file used. The detector 110 applies filters to rectangular groups of pixels of the frames to detect the faces. The detector also uses boosting.

Features 121 are extracted 120 from the frames where faces are detected. The features 121 for each frame include the number, size, and location of the faces in the frame. A confidence scores is also associated with each feature.

We sort the frames in each segment into a list based on the number of faces, and select a percentile point in the list that is greater than 50. If the selected point is the 50^{th} percentile, then the point is the median number of detected faces in each frame within a given time window. However, then it is possible that a lot of faces may be missed with, perhaps, fewer false alarms. Therefore, we increase the estimated per-frame number of faces. We prefer to select the 70^{th} percentile, instead of the 50^{th}, which biases our result to a higher number of detected faces.

This frame is selected 130 as the representative frame of the segment and we store the feature 131 of the representative frame. If there multiple frames with the same number of faces as the 70^{th} percentile point, then we select the frame with a largest size face as the representative frame. If there are still multiple frames with the same largest size, then we select the frame with the largest confidence score. We select the 70^{th} percentile point because the rate of missing faces is much higher than the relatively low rate of erroneously detecting faces due to pose variations.

If more than 80% of the frames in a segment do not include faces, then we mark the segment as ‘no-face’, and exclude that segment from a clustering process described below.

We determine 140 pair-wise distances of arrangements of the faces for all of the representative frames based on the stored features. The pair-wise distances form a distance matrix 141, shown here as intensity values. The distance matrix can be stored in a memory. Then, a spectral clustering process 150 applied to the distance matrix determines an optimal number of clusters 151 from the distances. The example distance matrix is for a typical ‘court TV’ program before 141 and after 151 clustering 150. The optimal number of clusters k is two.

Distance Determination

We modify a distance measure described by Abdel-Mottableb et al., “Content-Based Album Management Using Faces Arrangement,” ICME 2004, incorporated herein by reference.

However, because the number of faces can be different for the pair-wise frames to be matched, we first establish a correspondence between the faces present in the two frames. We minimize a relative spatial location distance, T_{D}, between each face of one frame of the pair, and all faces of the other frame. This distance T_{D} is given by:

$${T}_{D} = \frac{1}{M} [ \begin{matrix}\frac{{\sum }_{j = 1}^{M} \vert {L}_{1}^{j} - {L}_{2}^{j} \vert}{W} + \frac{{\sum }_{j = 1}^{M} \vert {W}_{1}^{j} - {W}_{2}^{j} \vert}{W} + \\ \frac{{\sum }_{j = 1}^{M} \vert {T}_{1}^{j} - {T}_{2}^{j} \vert}{W} + \frac{{\sum }_{j = 1}^{M} \vert {H}_{1}^{j} - {H}_{2}^{j} \vert}{W}\end{matrix} ] . \qquad ( 1 )$$

M faces from each frame (F₁ and F₂) are assigned indices j (1≦j≦M) such that face j in frame F₁ is paired with the corresponding face j in frame F₂, based on the established correspondence. The coordinates of the top-left corner of the rectangle for face j in the first frame F₁ are (L^{j}₁, T^{j}₁) and the coordinates for the cooresponding face in the second frame F₂ are (L^{j}₂, T^{j}₂). The width and height of the video sequence are W and H, respectively. The width and height of the rectangle for the j^{th} face in the first frame are W^{j}₁ and H^{j}₁ and, for the cooresponding face in the second frame, W^{j}₂ and H^{j}₂. The area of the rectangle for h face in first frame is A^{j}¹ while the area for the cooresponding face in the second frame is A^{j}₂.

After the correspondence between faces has been established based on the spatial locations, the distances between the two frames is determined as follows:
Dist(F₁,F₂)=αT_{D}+βT_{OV}+γT_{A}+(1−α−β−γ)T_{N}, (2)
where α, β, and γ are predetermined weighting parameters;

$${T}_{A} = 1 - \frac{1}{M} [ {\sum }_{j = 1}^{M} \frac{min ( {A}_{1}^{j} , {A}_{2}^{j} )}{max ( {A}_{1}^{j} , {A}_{2}^{j} )} ] ; \\ {T}_{OV} = 1 - \frac{1}{M} [ {\sum }_{j = 1}^{M} OverlappedSize ( {A}_{1}^{j} , {A}_{2}^{j} ) ] ; \\ {T}_{N} = \frac{\vert {NF}_{1} - {NF}_{2} \vert}{M} ; \qquad ( 3 )$$

OverlappedSize is the area of the rectangular overlap region between the face rectangle of face j from frame F₁ and the rectangle of face j from frame F₂; and NF₁ and NF₂ are the numbers of faces in the two frames F₁ and F₂ of the pair. The minimum of the number of faces between two frames is M.

We use Equation (2) to determine the pair-wise distances between representative frames of all the segments. A resulting symmetric distance matrix is then used in the spectral clustering as described below.

Spectral Clustering

Spectral clustering uses an eigenspace decomposition of a symmetric similarity matrix of items to be clustered. When optimizing the K-means objective function for a specific value of k, the continuous solutions for the discrete cluster indicator vectors are given by the first k−1 principal components of the similarity matrix, see Ding et al., “K-means Clustering via Principal Component Analysis,” Proceedings of the 21st International Conference on Machine Learning, ICML 2004. In that approach, a proximity or affinity matrix is determined from original items of the data set using a suitable distance measure.

Then, an eigenspace decomposition of the affinity matrix is used to group the dataset items into clusters. That approach has been proven to outperform K-means clustering, especially in the case of non-convex clusters resulting from non-linear cluster boundaries, see Ng et al., “On Spectral Clustering Analysis and an Algorithm,” Advances in Neural Information Processing Systems, Vol. 14, 2001.

Given the n×n symmetric affinity matrix 141 generated from face arrangement distance of frames, we determine an optimal number of clusters k and arrange the n sub-sampled windows into k clusters.

We simultaneously use k eigenvectors to perform a k-way partitioning of the data space into k clusters. Our decision for the number of clusters k computes the cluster validity score a similar to one described by F. Porikli F., T. Haga, “Event Detection by Eigenvector Decomposition using Object and Frame Features,” International Conference on Computer Vision and Pattern Recognition, CVPR 2004:

$$α = {\sum }_{c = 1}^{k} \frac{1}{{N}_{c}} {\sum }_{i , j ∈ {Z}_{c}} {W}_{ij} , \qquad ( 4 )$$

where Z_{c} denotes the cluster c, N_{c} is the number of items in cluster c, and W is the matrix formed out of Y, the normalized eigenvector matrix described below.

We use the following process to locate the number of clusters k and to perform the clustering:
1. Form the affinity matrix AεR^{n×n} defined by Aᵢⱼ=exp(−Dist(Fᵢ, Fⱼ)/2σ²), if i≠j, and Aᵢᵢ=0.
2. Define D to be the diagonal matrix whose (i, i)^{th} element is a sum of the i^{th} row of the affinity matrix, and construct a matrix L=D^{-1/2}AD^{-1/2}.
3. Locate n principal components x₁, x₂, . . . , xₙ of the diagonal matrix D.
4. Using a matrix formed by stacking the k largest principal components X=[x₁, x₂, . . . , xₖ] ε R_{n×k}, and form a normalized eigenvector matrix Y by renormalizing each row of X to have unit length,

$${Y}_{ij} = {X}_{ij} / {( {\sum }_{j} {X}_{ij}^{2} )}^{1 / 2} ,$$

and determine a n×n matrix W: W=Y·Y′.
5. Use K-means clustering on the rows of Y to form k clusters.
6. Determine the validity score aₖ.
7. Iterate the steps 4 through 6 for k=1, 2, . . . , K, and find a maxima of the validity score aₖ.

Although the process is partially based on K-means clustering, the functionality, as well as the results of our process, differs from the process that applies conventional K-means on the distances directly. This is due to the fact that the clusters in the original data space often correspond to non-convex regions, in which case K-means applied directly determines unsatisfactory clusters. Our process not only finds the clusters in this situation, but also determines an optimal number of clusters from the given data.

We then generate 160 a summary 109 of the video 101 using the clustered distance matrix. That is, interesting segments of the video are collected into the summary and uninteresting sections are removed. The face detection and spectral clustering as described above can sometimes generate overly fragmented video summaries. There can be many very short summary segments and many very short skipped segments. The short segments result in jerky or jumpy video playback. Therefore, smoothing can be applied to merge segments that are shorter than a threshold with an adjacent segment. We use morphological filtering to clean up the generated noisy summaries and to fill in gaps. After the summary is generated, a play back device can be used to view the summary.

### EFFECT OF THE INVENTION

The invention provides a method for unsupervised summarization of a variety of video genres. The method is based on face detection and spectral clustering. The method can detect multiple faces in frames and determines distances based on face features, such as the number, size, and location of the faces in frames of the video. The method determines an optimal number of clusters. The clusters are used to identify interesting segments and to collect the segments into a summary.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer implemented method for summarizing a video including a sequence of frames, comprising the steps of:
partitioning the video into segments of frames;
detecting faces in the frames of the segments;
extracting features of the frames including the faces;
selecting, for each segment including the faces, a representative frame based on the features;
determining, for each possible pair of representative frames, distances based on the faces;
arranging the distances in a matrix stored in a memory;
applying spectral clustering to the matrix to determine an optimal number of clusters;
summarizing the video according to the optimal number of clusters.

2. The method of claim 1, in which the video is compressed, and the faces are detected in DC images of the compressed video.

3. The method of claim 1, in which the video is an unknown genre.

4. The method of claim 1, in which the detecting uses rectangular filters applied to groups of pixels in the frames.

5. The method of claim 1, in which the segments overlap in time.

6. The method of claim 1, in which the features for each frame include a number, size and location of the faces in the frame.

7. The method of claim 1, further comprising:
associating a confidence score for each feature.

8. The method of claim 6, in which the selecting further comprises:
sorting the frames in each segment into a list based on the number of faces in the frame; and
selecting a percentile point in the list that is greater than 50 as the representative frame of the segment.

9. The method of claim 8, in which multiple frames have the same number of faces, and further comprising:
selecting the frame with a largest size face as the representative frame.

10. The method of claim 1, further comprising:
excluding a particular segment from further processing after the detecting if a predetermined percentage of the frames in the particular segment do not include faces.

11. The method of claim 1, further comprising:
determining a correspondence in each pair of representative frames by minimizing a relative spatial location distance, T_{D}, between each face of one representative frame of the pair and all faces of the other representative frame of the pair, the distance T_{D} being:
$${T}_{D} = \frac{1}{M} [ \begin{matrix}\frac{{\sum }_{j = 1}^{M} \vert {L}_{1}^{j} - {L}_{2}^{j} \vert}{W} + \frac{{\sum }_{j = 1}^{M} \vert {W}_{1}^{j} - {W}_{2}^{j} \vert}{W} + \\ \frac{{\sum }_{j = 1}^{M} \vert {T}_{1}^{j} - {T}_{2}^{j} \vert}{W} + \frac{{\sum }_{j = 1}^{M} \vert {H}_{1}^{j} - {H}_{2}^{j} \vert}{W}\end{matrix} ] ,$$
where M is the number of faces in each frame F₁ and F₂, j is an index from 1 to M such that face j in frame F₁ is paired with a corresponding face j in frame F₂, (L^{j}₁, T^{j}₁) are the coordinates of the top-left corner of the rectangle for face j in the first frame F₁, (L^{j}₂, T^{j}₂) are the coordinates of the top-left corner of the rectangle for the cooresponding face in the second frame F₂, W^{j}₁ and H^{j}₁ are the width and height of the rectangle for the j^{th} face in the first frame, W^{j}₂ and H^{j}₂ are the width and height of the rectangle for the cooresponding face in the second frame, and W is the width of the video sequence; and
determining the distance between the pair of representative frames as
Dist(F₁,F₂)=αT_{D}+βT_{OV}+γT_{A}+(1−α−β−γ)T_{N},
where α, β, and γ are predetermined weighting parameters,
$${T}_{A} = 1 - \frac{1}{M} [ {\sum }_{j = 1}^{M} \frac{min ( {A}_{1}^{j} , {A}_{2}^{j} )}{max ( {A}_{1}^{j} , {A}_{2}^{j} )} ] , \\ {T}_{OV} = 1 - \frac{1}{M} [ {\sum }_{j = 1}^{M} OverlappedSize ( {A}_{1}^{j} , {A}_{2}^{j} ) ] , \\ {T}_{N} = \frac{\vert {NF}_{1} - {NF}_{2} \vert}{M} ,$$
OverlappedSize is an area of overlap between a face rectangle of face j from frame F₁ and a rectangle of face j from frame F₂, NF₁ and NF₂ are numbers of faces in the two frames F₁ and F₂ of the pair, A^{j}₁ is the area of the rectangle for j^{th} face in first frame, and A^{j}₂ is the area for the cooresponding face in the second frame.

12. The method of claim 11, further comprising:
(a) forming a symmetric affinity matrix A from the distances according to Aᵢⱼ=exp(−Dist(Fᵢ, Fⱼ)/2σ²)⁻, where i≠j, Aᵢⱼ=0, and σ is a variance;
(b) defining a diagonal matrix D whose (i, i)^{th} element is a sum of the i^{th} row of the affinity matrix, and constructing a matrix L=D^{-1/2}A^{-1/2};
(c) locating n principal components x₁, x₂, . . . , xₙ of the diagonal matrix D;
(d) stacking k largest principal components in a vector X=[x₁, x₂, . . . , xₖ], and forming a normalized eigenvector matrix Y by renormalizing each row of X to have unit length,
$${Y}_{ij} = {X}_{ij} / {( {\sum }_{j} {X}_{ij}^{2} )}^{1 / 2} ,$$
and determining a n×n matrix W: W=Y·Yⁿ;
(e) applying K-means clustering on the rows of the eigenvector matrix Y to form k clusters;
(f) determining a validity score; and
(g) iterating steps (d) through (f) for k=1, 2, . . . , K, and finding a maximum of the validity score.

13. The method of claim 1, further comprising:
smoothing the summarized video by merging segments shorter than a predetermined length with adjacent segments.
